(19) United States
(12) Patent Application Publication
(10) Pub. No.: US 2010/0093394 A1
(43) Pub. Date: Apr. 15, 2010

(54) MOBILE TERMINAL SYSTEM, MOBILE TERMINAL, EXTERNAL DEVICE, AND INPUT/OUTPUT METHOD OF MOBILE TERMINAL

(76) Inventor: Isao HIDAKA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/578,279

(22) Filed: Oct. 13, 2009

(30) Foreign Application Priority Data
Oct. 15, 2008 (JP) P2008-266856

(51) Int. Cl. H04M 1/00

(52) U.S. Cl. 455/557

(57) ABSTRACT

A mobile terminal system including a mobile terminal and an external device is provided. The mobile terminal includes a first external device interface to output screen information to the external device and to receive operation information from the external device. The external device includes a display section to display and output the screen information, a user input section used when a user inputs the operation information on the mobile terminal, and a second external device interface to receive the screen information from the mobile terminal and to output to the mobile terminal the operation information input through the user input section. Transmission of the screen information and the operation information between the first and second external device interfaces is performed through a power signal used for the supply of power to the mobile terminal or for charging a battery in the mobile terminal.

### BACKGROUND OF THE INVENTION

1. Field of the Invention

The present invention relates to a mobile terminal system including a mobile terminal which receives image data and sound data, such as a mobile phone, and an external device connected to the mobile terminal, a mobile terminal, an external device, and an input/output method of the mobile terminal. In particular, the present invention relates to a mobile terminal system which outputs image data and sound data received in a mobile terminal to the outside through an external device and which allows the performance of a user operation on the mobile terminal through the external device, a mobile terminal, an external device, and an input/output method of the mobile terminal.

2. Description of the Related Art

Mobile phones have succeeded the carphones pioneered as a mobile communications system, and have rapidly spread since the 1990s as the terminals become small, light, and inexpensive and the service charges become low. Moreover, with the spread of computers and the development of broadband network techniques including the Internet, E-mail and web search/access can be performed on mobile phones and various applications, such as music or video reproduction and games, can be executed.

However, although the range of application of mobile phones is diversified, there are many restrictions in input and output since a portable size is necessary for mobile phones. For example, the screen size is diagonally about 5 to 10 cm. In this case, high-resolution display causes problems in visibility, for example, characters with the same font size become very small, even though the resolution is increasing due to the development of flat panel manufacturing technology in recent years.

Furthermore, an input section provided in the mobile phone generally has only a numeric keypad of 0 to 9, keys by which up and down and left and right input operations are possible, and some other keys. Compared with a keyboard of a personal computer provided with 60 to 100 keys, the number of keys of the mobile phone is small and the input operation is also difficult.

In recent years, the mobile phone with tens of keys similar to the QWERTY type keyboard has also appeared. However, each of the keys is small due to the portability restriction on the device size. For this reason, the input operation is still difficult.

In order to cope with such a problem, a method of connecting a mobile phone to an external device with a relatively large screen or an input device which is easy to perform an input operation may be considered.

For example, a display processing system using a mobile terminal is proposed. In the display processing system, an image displayed on a liquid crystal screen of a mobile phone can be displayed on a television screen (for example, refer to Japanese Unexamined Patent Application Publication No. 2001-352373).

In addition, a screen display device which has an entry for connecting a mobile phone is proposed. The screen display device displays image data received in the mobile phone on a large screen (for example, refer to Japanese Unexamined Patent Application Publication No. 2002-116843).

In addition, a mobile phone with a separate monitor is proposed. The mobile phone displays data displayed on a monitor built in the mobile phone or downloaded display data on the separate monitor (for example, refer to Japanese Unexamined Patent Application Publication No. 2003-78597).

However, in order to transmit or receive data by connecting a mobile phone to an external device, a plurality of signal transmission lines for input/output of a video signal, input/output of a sound signal, input/output of a user operation signal, and the like is necessary (refer to FIG. 10). That is, for the connection between the mobile phone and the external device, a plurality of cables is used for video, sound, and user operation or a plug cable having a terminal with many poles is used. In the former case where a plurality of cables is used, the connection and disconnection operations of the cables are troublesome for the user. Moreover, in the latter method of using the plug cable, there is a problem that it becomes difficult to secure the place for disposing the plug in the main body of the small mobile phone as the number of poles increases. In addition, problems also occur such as the device becoming expensive due to the cost of components, such as connectors, and difficulty in obtaining a contact point between the connectors with sufficient strength.

In addition, when the classification of input or output signal changes with the model of the mobile phone, the number of poles of the plug also changes. In this case, the connectors for the external device are not compatible among different models, which is inconvenient.

### SUMMARY OF THE INVENTION

In view of the above, it is desirable to provide a mobile terminal system that includes a mobile terminal which receives image data and sound data, such as a mobile phone, and an external device connected to the mobile terminal and that can output the image data and the sound data received in the mobile terminal to the outside through the external device and allow the performance of a user operation on the mobile terminal through the external device, a mobile terminal, an external device, and an input/output method of the mobile terminal.

In addition, it is desirable to provide a mobile terminal system in which a mobile terminal and an external device are connected to each other by an interface with a simple configuration so that image data and sound data received in the mobile terminal can be output to the outside through the external device and a user operation can be performed on the mobile terminal through the external device, a mobile terminal, an external device, and an input/output method of the mobile terminal.

According to a first embodiment of the present invention, a mobile terminal system including a mobile terminal and an external device includes: a first external device interface which is provided in the mobile terminal in order to output screen information to the external device and to receive operation information from the external device; a display section which is provided in the external device in order to display and output the screen information; a user input section which is provided in the external device and is used when a user inputs the operation information on the mobile terminal; and a second external device interface which is provided in the external device in order to receive the screen information from the mobile terminal and to output to the mobile terminal the operation information input through the user input section. Transmission of the screen information and the operation information between the first and second external device interfaces is performed through a power signal used for the supply of power to the mobile terminal or for charging a battery in the mobile terminal.

The “system” referred to herein means a logical group of a plurality of devices (or functional modules for realizing specific functions), and it does not matter whether the devices or the functional modules exist in a single housing.

According to a second embodiment of the present invention, a mobile terminal system including a mobile terminal and an external device includes: a first external device interface which is provided in the mobile terminal in order to output screen information to the external device and to receive operation information from the external device; a display section which is provided in the external device in order to display and output the screen information; a user input section which is provided in the external device and is used when a user inputs the operation information on the mobile terminal; and a second external device interface which is provided in the external device in order to receive the screen information from the mobile terminal and to output to the mobile terminal the operation information input through the user input section. Each of the first and second external device interfaces includes a coil, and transmission of the screen information and the operation information is performed using the electric field between the coils.

Here, according to a third embodiment of the present invention, the coil provided in the first external device interface may be a coil for power reception, the coil provided in the second external device interface may be a coil for power transmission, and a battery in the mobile terminal may be charged by using electromagnetic induction between the coils. That is, the “power signal” superimposed on the screen information and the operation information is assumed to include not only a current signal transmitted on a power cable but also various forms of signals transmitted on the media used for the power supply, such as a magnetic signal in a non-contact charge mechanism that uses electromagnetic induction between the coil for power transmission and the coil for power reception.

In addition, according to a fourth embodiment of the present invention, the mobile terminal may be a mobile phone, and the screen information may be video data or still image data received through a mobile phone network.

In addition, according to a fifth embodiment of the present invention, the first and second external device interfaces may perform parallel-to-serial conversion of transmission data and superimpose the converted data on the power signal and may reproduce received data superimposed on the power signal by performing serial-to-parallel conversion of the received data.

In addition, according to a sixth embodiment of the present invention, a mobile terminal that operates in the mobile terminal system according to the first embodiment of the present invention includes: a display section which outputs screen information; a user input section which is used when a user inputs operation information on the mobile terminal; a first external device interface for transmitting the screen information to the external device and receiving the operation information from the external device through a power signal used for the supply of power to the mobile terminal or for charging a battery in the mobile terminal; and a processor which outputs the screen information to the display section or the first external device interface and performs an operation of the mobile terminal according to the operation information input by the user input section or the operation information read from the first external device interface.

In addition, according to a seventh embodiment of the present invention, a mobile terminal that operates in the mobile terminal system according to the first embodiment of the present invention includes: a display section which outputs screen information; a user input section which is used when a user inputs operation information on the mobile terminal; a first external device interface which includes a coil and transmits the screen information to the external device and receives the operation information from the external device using the electric field of the coil; and a processor which outputs the screen information to the display section or the first external device interface and performs an operation of the mobile terminal according to the operation information input by the user input section or the operation information read from the first external device interface.

Here, according to an eighth embodiment of the present invention, the coil provided in the first external device interface may be a coil for power reception, the coil provided in the second external device interface may be a coil for power transmission, and a battery in the mobile terminal may be charged by using electromagnetic induction between the coils. That is, the “power signal” superimposed on the screen information and the operation information is assumed to include not only a current signal transmitted on a power cable but also various forms of signals transmitted on the media used for the supply of power, such as a magnetic signal in a non-contact charge mechanism that uses electromagnetic induction between the coil for power transmission and the coil for power reception.

In addition, according to a ninth embodiment of the present invention, the first external device interface of the mobile terminal may perform parallel-to-serial conversion of transmission data and superimpose the converted data on the power signal and may reproduce received data superimposed on the power signal by performing serial-to-parallel conversion of the received data.

In addition, according to a tenth embodiment of the present invention, an external device that operates in the mobile terminal system according to the first embodiment of the present invention includes: a user input section which is used when a user inputs operation information on the mobile terminal; a second external device interface for receiving the screen information from the mobile terminal and transmitting the operation information to the mobile terminal through a power signal used for the supply of power to the mobile terminal or for charging a battery in the mobile terminal; and a display section which outputs the screen information received from the mobile terminal.

In addition, according to an eleventh embodiment of the present invention, an external device that operates in the mobile terminal system according to the first embodiment of the present invention includes: a user input section which is used when a user inputs operation information on the mobile terminal; a second external device interface which includes a coil and receives the screen information from the mobile terminal and transmits the operation information to the mobile terminal using the electric field of the coil; and a display section which outputs the screen information received from the mobile terminal.

Here, according to a twelfth embodiment of the present invention, the coil provided in the first external device interface may be a coil for power reception, the coil provided in the second external device interface may be a coil for power transmission, and a battery in the mobile terminal may be charged by using electromagnetic induction between the coils. That is, the “power signal” superimposed on the screen information and the operation information is assumed to include not only a current signal transmitted on a power cable but also various forms of signals transmitted on the media used for the supply of power, such as a magnetic signal in a non-contact charge mechanism that uses electromagnetic induction between the coil for power transmission and the coil for power reception.

In addition, according to a thirteenth embodiment of the present invention, the second external device interface of the external device may perform parallel-to-serial conversion of transmission data and superimpose the converted data on the power signal and may reproduce received data superimposed on the power signal by performing serial-to-parallel conversion of the received data.

In addition, according to a fourteenth embodiment of the present invention, an input/output method of a mobile terminal in the mobile terminal system according to the first embodiment of the present invention includes the steps of: outputting the screen information from the first external device interface provided in the mobile terminal; performing display output of the screen information, which has been input to the second external device interface provided in the external device, in the display section of the external device; outputting the operation information, which has been input through the user input section of the external device, from the second external device interface; and operating the mobile terminal according to the operation information input to the first external device interface. Transmission of the screen information and the operation information between the first and second external device interfaces is performed through a power signal used for the supply of power to the mobile terminal or for charging a battery in the mobile terminal.

In addition, according to a fifteenth embodiment of the present invention, an input/output method of a mobile terminal in the mobile terminal system according to the first embodiment of the present invention includes the steps of: outputting the screen information from the first external device interface provided in the mobile terminal; performing display output of the screen information, which has been input to the second external device interface provided in the external device, in the display section of the external device; outputting the operation information, which has been input through the user input section of the external device, from the second external device interface; and operating the mobile terminal according to the operation information input to the first external device interface. Each of the first and second external device interfaces includes a coil, and transmission of the screen information and the operation information is performed using the electric field between the coils.

According to the embodiments of the present invention, it is possible to provide the excellent mobile terminal system that includes a mobile terminal which receives image data and sound data, such as a mobile phone, and an external device connected to the mobile terminal and that can output the image data and the sound data received in the mobile terminal to the outside through the external device and allow the performance of a user operation on the mobile terminal through the external device, the mobile terminal, the external device, and the input/output method of the mobile terminal.

Moreover, according to the embodiments of the present invention, it is possible to provide the excellent mobile terminal system in which a mobile terminal and an external device are connected to each other by an interface with a simple configuration so that image data and sound data received in the mobile terminal can be output to the outside through the external device and a user operation can be performed on the mobile terminal through the external device, the mobile terminal, the external device, and the input/output method of the mobile terminal.

According to the first to third, sixth to eighth, tenth to twelfth, fourteenth, and fifteenth embodiments of the present invention, the received data can be displayed on the large screen and the mobile terminal can be operated by the input from an easy-to-use keyboard simply by placing the mobile terminal, in which the size of the display device or input device is not sufficient, on the external device.

In addition, according to the fourth embodiment of the present invention, video data or still image data downloaded from the Internet to the mobile phone can be displayed using the large screen of the external device.

In addition, according to the fifth, ninth, and thirteenth embodiments of the present invention, transmission using a small number of contact points is performed between the mobile phone and the external device. This is advantageous in that the connection interface is simplified, the component cost for the connection section is reduced, the device is small-sized, and deterioration of the contact point is prevented. These effects can be further improved by applying wireless connection, such as electric field transmission, to the connection interface.

Moreover, according to the embodiments of the present invention, since it is sufficient to provide a simple connection interface with an external device, restrictions in the design can be reduced.

Additional purposes, characteristics, and advantages of the present invention will be apparent from the detailed description made in the following embodiment of the present invention with reference to the accompanying drawings.

### BRIEF DESCRIPTION OF THE DRAWINGS

FIG. 1 is a diagram schematically illustrating the configuration of a mobile terminal system according to an embodiment of the present invention;

FIG. 2 is a diagram illustrating an example of the configuration of transmitting the parallel data serially;

FIG. 3 is a characteristic curve illustrating the frequency spectrum of a signal on a power line;

FIG. 4A is a diagram illustrating another example of the serializer which transmits the parallel data serially;

FIG. 4B is a diagram illustrating another example of the serializer which transmits the parallel data serially;

FIG. 5 is a diagram illustrating a write sequence example of a bus in a mobile phone and a bus in an external device when performing a write operation from the mobile phone to an LCD of the external device;

FIG. 6 is a diagram illustrating a read sequence example of a bus in the mobile phone and a bus in the external device when performing an operation of reading the input information on a keyboard of the external device from the mobile phone;

FIG. 7 is a diagram illustrating an interrupt sequence example of the bus in the mobile phone and the bus in the external device when an interrupt occurs on the keyboard of the external device;

FIG. 8 is a diagram illustrating a format example of a transmission frame between the mobile phone and the external device;

FIG. 9 is an illustration of an application image of the mobile terminal system shown in FIG. 1; and

FIG. 10 is a diagram illustrating an example of the configuration of a past mobile terminal system.

### DESCRIPTION OF THE PREFERRED EMBODIMENTS

Hereinafter, embodiments of the present invention will be described with reference to the accompanying drawings.

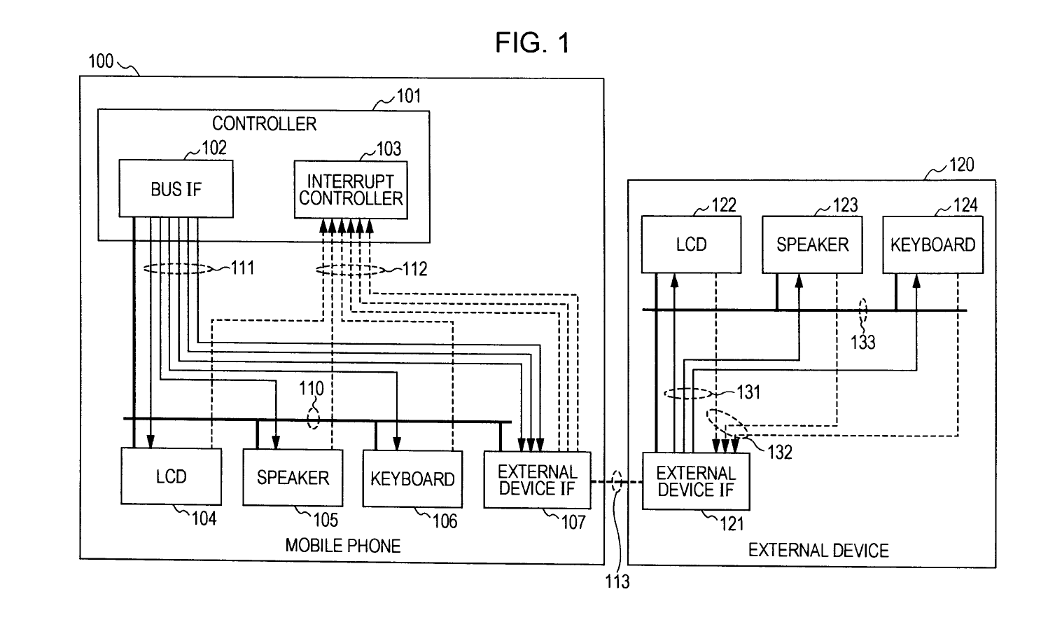

FIG. 1 is a schematic diagram illustrating the configuration of a mobile terminal system according to an embodiment of the present invention. The system shown in FIG. 1 includes a mobile phone, which receives image data and sound data, and an external device, which outputs the image data and the sound data to the outside or which is used when a user operates the mobile phone.

A mobile phone 100 includes a processor 101, various input/output devices 104 to 106, and an external device interface 107 for interfacing with an external device 120. Moreover, although the mobile phone 100 includes circuit modules for radio communications and the like, they are not shown because they are not directly related with the gist of the present invention.

The processor 101 is connected to the various input/output devices 104 to 106 by a bus signal line group 110, a chip select signal 111, and an interrupt signal 112.

The bus signal line group 110 includes signal lines, such as address, data, and enable. In addition to the various input/output devices 104 to 106, the bus signal line group 110 is also connected to the external device interface 107.

The chip select signal 111 is a signal which is used when the processor 101 selects a circuit chip of one of the various input/output devices 104 to 106 through a bus interface 102. In addition, the interrupt signal 112 is a signal, which is used when the various input/output devices 104 to 106 notify the processor 101 of the occurrence of an event, and is input to an interrupt controller 103. The chip select signal 111 and the interrupt signal 112 are prepared in a quantity equal to the number of input/output devices and are also connected to the external device interface 107.

First, an operation on the side of the mobile phone 100 will be described.

When outputting data to the screen of an LCD 104, the processor 101 outputs image data to the LCD 104 using the bus interface 102. When outputting the data to the LCD 104, the bus interface 102 enables the chip select signal 111 connected to the LCD 104 so that the LCD 104 receives the image data from the processor 101 and displays the data on the screen. For example, video data or still image data downloaded through the mobile phone network from a web site on the Internet can be displayed on the screen of the LCD 104.

In addition, also when outputting data to a speaker 105 or other output devices (not shown), the processor 101 similarly enables only the chip select signal 111 connected to the corresponding output device so that the output device receives the data from the processor 101 and reproduces and outputs the data. For example, sound data, such as music, downloaded through the mobile phone network from a web site on the Internet can be reproduced in the speaker 105.

On the other hand, when there is a user input operation on a keyboard 106, the keyboard 106 generates an interrupt and notifies the interrupt controller 103 of the processor 101 through the interrupt signal 112. The processor 101 which has received the interrupt receives the data, which has been input on the keyboard 106, through the bus 110. In this case, the bus interface 102 enables the chip select signal 111 connected to the keyboard 106 so that the keyboard 106 can output the data to the bus 110 and the processor 101 can receive the data.

In addition, the same is true for the cases where an input operation has been performed by other input devices (not shown). That is, the input device generates an interrupt in response to the user input operation and notifies the interrupt controller 103 of the processor 101 through the interrupt signal 112. On the other hand, the bus interface 102 enables the chip select signal 111 connected to the corresponding input device so that the input device outputs the data to the bus 110 and the processor 101 receives the data.

Having described the data input/output operations between the input/output devices 104 to 106 and the processor 101, it may be understood that read and write operations of common registers for each input/output device are similarly realized by the above-described bus access method.

In the system shown in FIG. 1, the mobile phone 100 is connected to the external device 120 through the external device interfaces 107 and 121. The external device 120 includes various enhanced input/output devices as user interfaces, such as an LCD 122 with a relatively large screen, a multi-channel speaker 123, and a large-sized keyboard 124 with tens of keys, such as alphanumeric keys. In addition, although not shown, the external device 120 may have a charge function for the mobile phone 100.

In the past, a method of using a plug cable was commonly adopted for connection between a mobile phone and an external device. In this case, however, there are some problems as already stated. On the other hand, in the present embodiment, the external device interfaces 107 and 121 perform parallel-to-serial conversion of the address information and data information transmitted through the bus and then transmit this information under the conditions in which it is superimposed on a power interface 113. For this reason, neither the number of cables nor the number of poles of the plug is increased.

Next, a method of transmitting and receiving data under the conditions in which the external device 120 is connected to the mobile phone 100 will be described.

First, the case where the screen information of the mobile phone 100 is output to the external device 120 will be described.

The bus interface 102 enables the chip select signal 111 connected to the external device interface 107 so that the external device interface 107 can receive from the processor 101 the data to be displayed on the screen. In this case, it is assumed that the chip select signal 111 includes the classification indicating that transmitted data is screen information.

The external device interface 107 performs parallel-to-serial conversion of the classification of the chip select signal 111 and the address information and data information transmitted through the bus 110 and transmits such data to the power interface 113.

The external device interface 121 of the external device 120 includes a bus interface function (not shown) and an interrupt controller function (not shown). In addition, the external device interface 121 converts the serial data, which has been received from the mobile phone 100 through the power interface 113, into parallel data to thereby restore it as the same data as in the mobile phone 100 which includes the classification of the chip select signal 111, the address information, and the data information. Then, the external device interface 121 transmits the data to the LCD 122 through a bus 133 by enabling a chip select signal 131 connected to the LCD 122. Thus, the LCD 122 displays and reproduces the same screen information as in the mobile phone 100. For example, video data or still image data downloaded from a web site on the Internet to the mobile phone 100 through the mobile phone network can be displayed on the screen of the LCD 122 in the external device 120.

Moreover, the same is true for the case where the other output information on the side of the mobile phone 100 is output to the external device 120.

For example, when the sound information is output to the external device 120, the bus interface 102 enables the chip select signal 111 connected to the external device interface 107 so that the data for sound output is transmitted from the processor 101 to the external device interface 107. In this case, the chip select signal 111 includes the classification indicating that the transmitted data is sound information. Then, the external device interface 107 performs parallel-to-serial conversion of the classification of the chip select signal 111 and the address information and data information transmitted through the bus 110 and transmits such data to the power interface 113. On the other hand, the external device interface 121 of the external device 120 reproduces the same data as in the mobile phone 100 by performing serial-to-parallel conversion of the classification of the received chip select signal 111, the address information, and the data information and then transmits the data to the speaker 123 through the bus 133 by enabling the chip select signal 131 connected to the speaker 123. Thus, the speaker 123 reproduces and outputs the same sound information as in the mobile phone 100. For example, sound data, such as music, downloaded from a web site on the Internet to the mobile phone 100 through the mobile phone network can be reproduced in the speaker 123 of the external device 120.

Next, a processing operation when a user input operation is performed using an input device of the external device 120 will be described.

For example, when there is a user input operation on the keyboard 124, the keyboard 124 generates an interrupt and notifies the external device interface 121 through an interrupt signal 132.

Upon receiving the interrupt signal, the external device interface 121 receives the data input on the keyboard 124 through the bus 133 by enabling the chip select signal 131 connected to the keyboard 124. Then, the external device interface 121 performs parallel-to-serial conversion of the classification of the chip select signal 131 and the address information and data information transmitted through the bus 132 and transmits such data to the power interface 113.

Then, the external device interface 107 of the mobile phone 100 converts the serial data, which has been received from the external device 120 through the power interface 113, into parallel data to thereby restore it as the same data as in the external device 120 which includes the classification of the chip select signal 131, the address information, and the data information. In addition, the external device interface 107 generates an interrupt and notifies the interrupt controller 103 of the processor 101 through the interrupt signal 112.

When the processor 101 receives the interrupt, the bus interface 102 enables the chip select signal 111 connected to the external device interface 107. In response to this, the external device interface 107 outputs the data to the bus 110. Thus, the processor 101 can receive the data input by the keyboard 124 of the external device 120.

Moreover, the same is true for the case where other input information on the side of the external device 120 is input to the mobile phone 100.

That is, the input device generates an interrupt in response to the user input operation or the like and notifies it to the external device interface 121. Upon receiving the interrupt signal, the external device interface 121 receives the data through the bus 133 by enabling the chip select signal 131 connected to the corresponding input device. Then, the external device interface 121 performs parallel-to-serial conversion of the classification of the chip select signal 131 and the address information and data information transmitted through the bus 132 and transmits such data to the power interface 113.

The external device interface 107 of the mobile phone 100 performs serial-to-parallel conversion of the classification of the chip select signal 131, the address information, and the data information which have been received from the external device 120, thereby restoring the same data as in the external device 120. In addition, the external device interface 107 notifies the interrupt controller 103 of the processor 101 through the interrupt signal 112 that there has been an input from the external device 120. Then, the bus interface 102 enables the chip select signal 111 connected to the external device 120 so that the processor 101 receives the input data from the external device 120.

Having described the data input/output operations between the input/output devices 122 to 124 of the external device 120 and the processor 101 of the mobile phone 100, it may be understood that read and write operations of common registers for each input/output device of the external device 120 are similarly realized by the above-described bus access method.

In the present embodiment, interface between the mobile phone 100 and the external device 120 is simplified by adopting the method in which the external device interfaces 107 and 121 perform parallel-to-serial conversion of the address information and data information transmitted through the bus and then transmit such data under the conditions in which they are superimposed on the power interface 113.

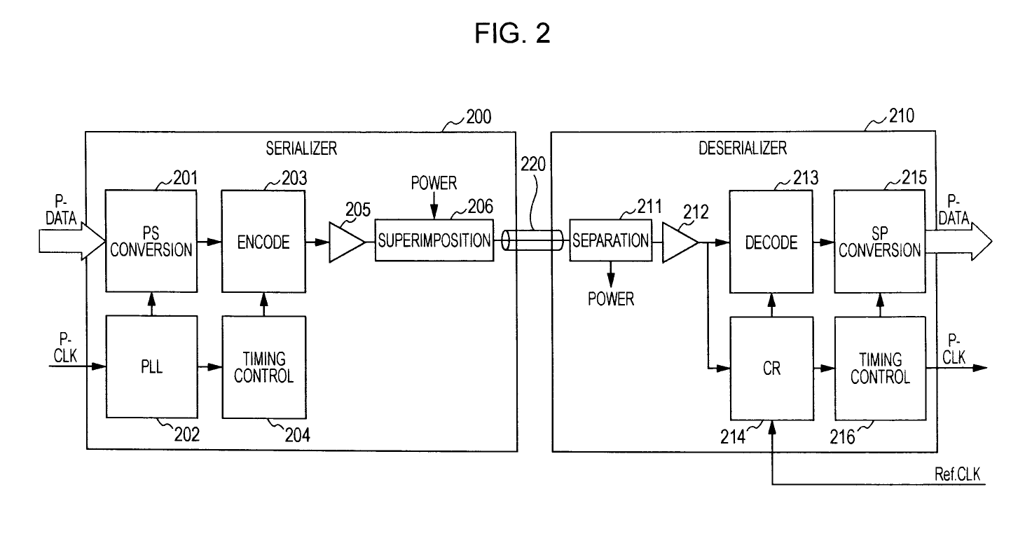

FIG. 2 illustrates an example of the configuration of transmitting the parallel data serially. The transmission system shown in FIG. 2 includes a serializer 200 and a deserializer 210 which are connected to each other through a power line 220 as the power interface 113. It is assumed that the pair of serializer 200 and deserializer 210 is bidirectionally disposed in the external device interface 107 of the mobile phone 100 and the external device interface 121 of the external device 120.

The serializer 200 includes a PS (parallel to serial) converter 201 which converts a parallel signal into a serial signal, a PLL section 202 which generates a serial clock from a clock (P-CLK) for parallel data, an encoder 203 which performs encoding by adding a header and the like to the serial signal, a timing controller 204 which controls the transmission timing, and a driver 205.

On the other hand, the deserializer 210 includes a receiver 212, a decoder 213 which decodes the coded data by detecting the head of the data from the header, a clock recovery (CR) section 214 which extracts a clock from the received data using a reference clock (Ref. CLK), an SP (serial to parallel) converter 215 which converts the serial signal to the original parallel signal, and a timing controller 216 which controls the reception timing.

Thus, parallel data P-DATA and a clock P-CLK for serial data which are input to the serializer 200 are converted into serial signals, and are restored to the original parallel data P-DATA and clock P-CLK by the deserializer 210.

In the example shown in FIG. 2, the power line 220 is used as a transmission line, and the serial signal is transmitted under the conditions in which it is superimposed on the power line 220 from the external device 120 to the mobile phone 100. A superimposition section 206 superimposes the transmission signal on the power signal used for power supply. Basically, the superimposition section 206 couples the transmission signal with the power line 220 by a capacitor and couples the power signal with the power line 220 by a choke coil.

The transmission signal which arrives at the deserializer 210 through the power line 220 is separated from the power signal by a separation section 212. Similar to the superimposition section 206, in the separation section 211, the transmission signal is extracted after a DC component is cut by a capacitor, and the power signal is cut from the transmission signal by a choke coil.

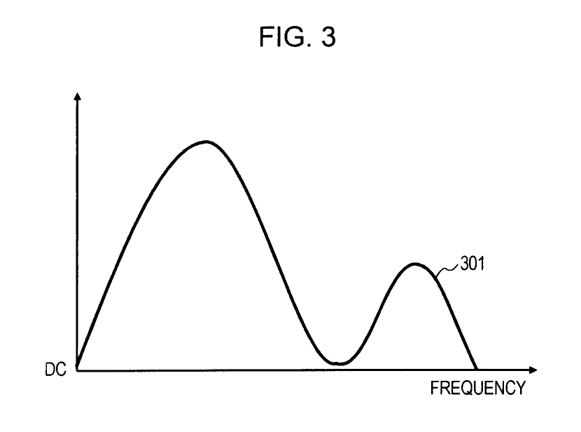

In addition, Manchester encoding may be mentioned as an example of the encoding method applied in the encoder 203 and the decoder 213. In the Manchester encoding, when a binary value “0” is transmitted, it is changed from high level to low level in the middle of the bit section. On the other hand, when a binary value “1” is transmitted, it is conversely changed from low level to high level in the middle of the bit section. In other words, in the Manchester encoding, the DC component of the transmission signal is removed by extending the band twice. Since the Manchester code is advantageous in that a DC component is not included and extraction of a clock is easy, it is thought that the Manchester code is suitable to be superimposed on the same transmission line as the power with a DC component. The frequency spectrum of a signal on the power line 220 is shown in FIG. 3. In FIG. 3, reference numeral 301 denotes the frequency spectrum of a Manchester code. It is known that the Manchester code can be transmitted together with the power signal without including a DC component.

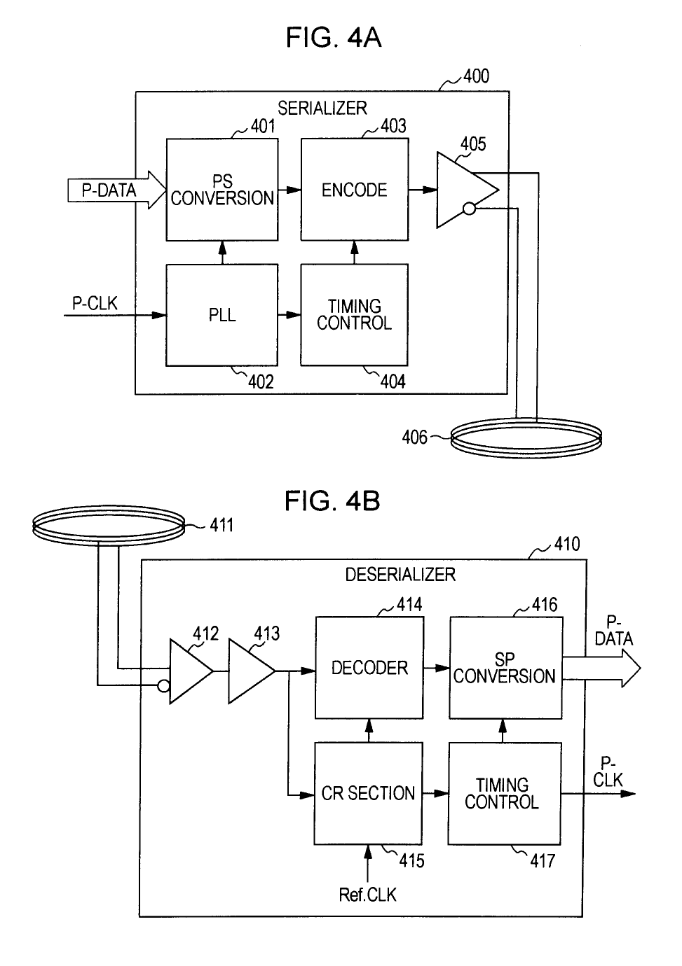

Another configuration example of a serializer, which transmits the parallel data serially, and a deserializer is shown in FIGS. 4A and 4B.

A serializer 400 includes a PS converter 401 which converts a parallel signal into a serial signal, a PLL section 402 which generates a serial clock from a clock (P-CLK) for parallel data, an encoder 403 which performs encoding by adding a header and the like to the serial signal, a timing controller 404 which controls the transmission timing, and a driver 405. The serial signal encoded in the encoder 403 is transmitted to a coil 406 through the driver 405 and is then transmitted to a deserializer 410 by electromagnetic coupling between coils.

On the other hand, the deserializer 410 includes a coil 411 which performs electromagnetic coupling with the coil 406 on the side of the serializer 400, a differential receiver 412, an amplifier 413 which amplifies the signal level decreased by the electromagnetic coupling, a decoder 414 which detects the head of the data from the header and decodes the coded data, a clock recovery (CR) section 415 which extracts a clock from the received data using a reference clock (Ref. CLK), an SP converter 416 which converts the serial signal to the original parallel signal, and a timing controller 417 which controls the reception timing.

When the serial transmission shown in FIG. 2 or FIGS. 4A and 4B is applied as the power interface 113 which connects the external device 120 and the mobile phone 100 to each other, the data may be superimposed on the power signal and data transmission may be performed while performing charging from the external device 120 to the mobile phone 100. In addition, according to the serial transmission method shown in FIGS. 4A and 4B, data transmission in the electric field using the coils is possible. As a result, since data can be transmitted and received through wireless connection, a cable which connects the external device 120 with the mobile phone 100 becomes unnecessary.

Next, a bus access operation when performing data transmission and reception between the mobile phone 100 and the external device 120 will be described. Hereinbelow, the bus access operation will be described according to the 80 based bus architecture of Intel Co., USA. However, the present invention is not limited thereto.

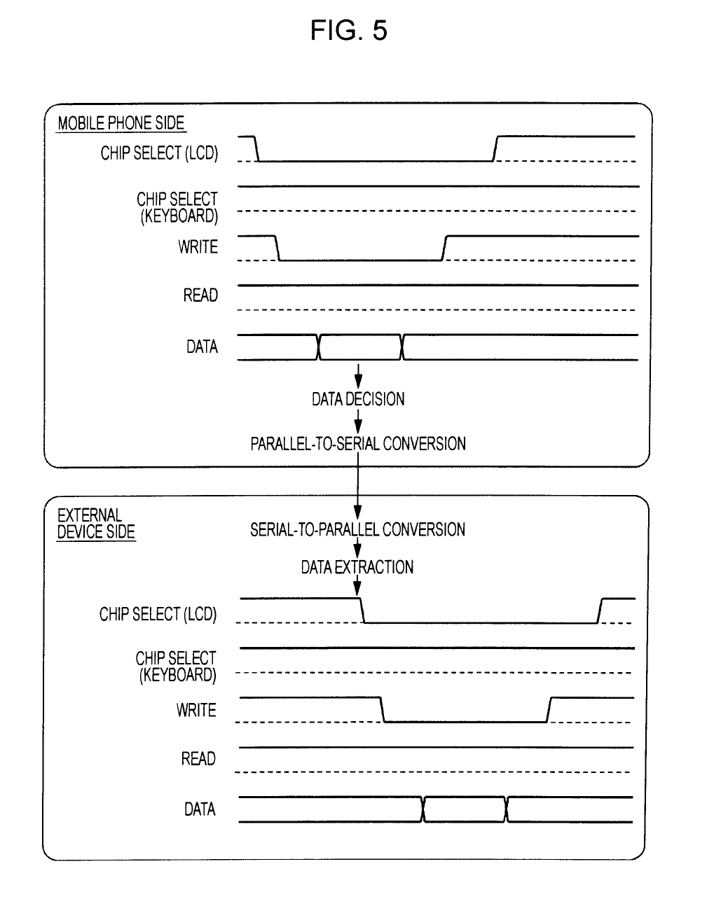

FIG. 5 illustrates a write sequence example of the bus 110 in the mobile phone 100 and the bus 133 in the external device 120 when performing a write operation from the mobile phone 100 to the LCD 122 of the external device 120.

In the mobile phone 100, a chip select signal having an LCD classification is asserted (enabled) by the processor 101. Subsequently, the write signal on the bus 110 is asserted by the processor 101 and then the write data is transmitted to the bus 110.

By such an operation, data is written in the external device interface 107 of the mobile phone 100. Then, the external device interface 107 performs parallel-to-serial conversion of the signal (address information and data information) which is requested to be written and serially transmits the converted signal to the external device 120 through the power interface 113.

The external device interface 121 of the external device 120 extracts the classification of the chip select signal 111, the address information, and the data information by converting the received serial data into parallel data. Subsequently, the external device interface 121 asserts the chip select signal connected to the LCD 122, asserts the write signal on the bus 133, and then transmits the write data to the bus 110. Thus, writing of the data into the LCD 122 is performed. As a result, the LCD 122 can display and reproduce the same screen information as in the mobile phone 100.

In addition, it may be understood that the same bus write sequence is performed in each of the mobile phone 100 and the external device 120 also in cases where other output information from the mobile phone 100 is written in the external device 120.

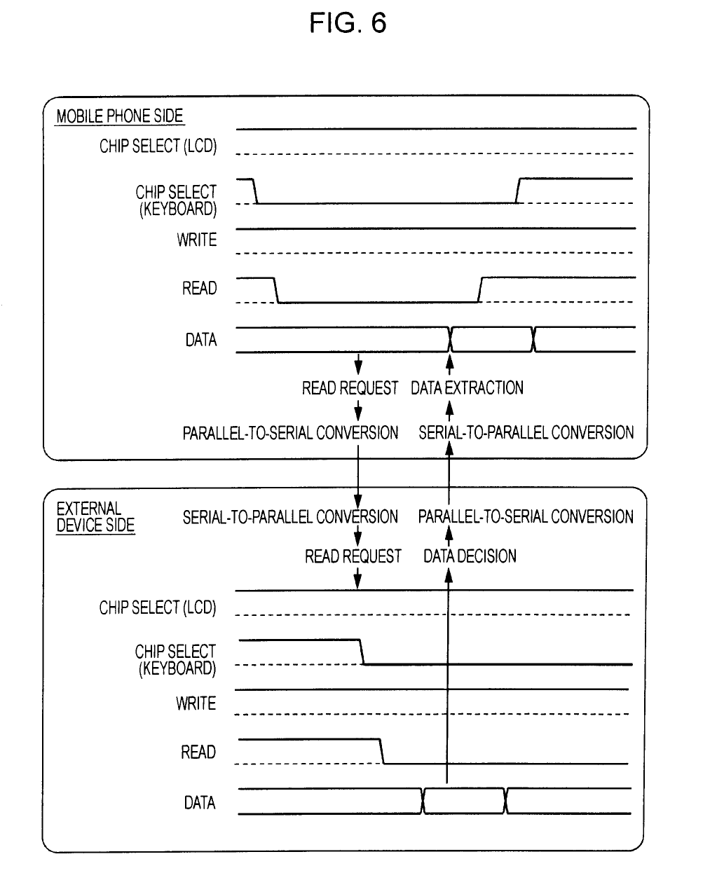

FIG. 6 illustrates a read sequence example of the bus 110 in the mobile phone 100 and the bus 133 in the external device 120 when performing an operation of reading the input information on the keyboard 124 of the external device 120 from the mobile phone 100.

In the mobile phone 100, a chip select signal having a keyboard classification is asserted and then a read signal on the bus 110 is asserted by the processor 101. Then, the external device interface 107 of the mobile phone 100 performs parallel-to-serial conversion of the signal (address information and data information) which is requested to be read and serially transmits the converted signal to the external device 120 through the power interface 113.

The external device interface 121 of the external device 120 extracts the classification of the chip select signal 111, the address information, and the data information by converting the received serial data into parallel data. Then, the external device interface 121 asserts the chip select signal connected to the keyboard 124 and then asserts the read signal on the bus 133. Then, the keyboard 124 transmits the input data to the bus 110.

After reading the data from the keyboard 124, the external device interface 121 converts the data into serial data and serially transmits it to the mobile phone 100 through the power interface 113.

The external device interface 107 of the mobile phone 100 extracts the input data on the keyboard 124 by converting the received serial data into parallel data and then transmits it to the bus 110 during a period for which the read signal is asserted. Thus, the processor 101 can read the input data from the keyboard 124 of the external device 120.

In addition, it may be understood that the same bus read sequence is performed in each of the mobile phone 100 and the external device 120 also in cases where other input information of the external device 120 is read in the mobile phone 100.

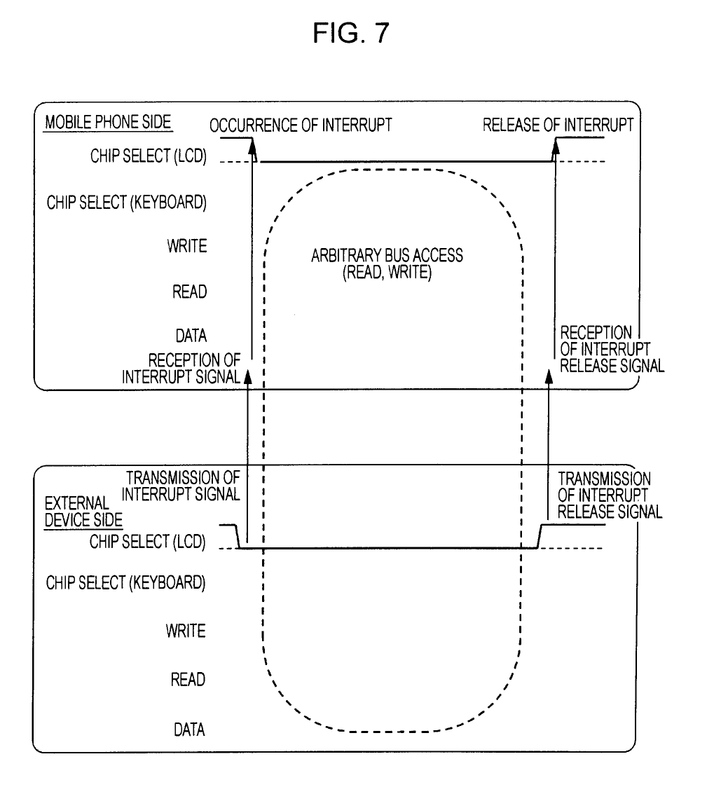

FIG. 7 illustrates an interrupt sequence example of the bus 110 in the mobile phone 100 and the bus 133 in the external device 120 when an interrupt occurs on the keyboard 124 of the external device 120.

The keyboard 124 asserts the interrupt signal 132 when an interrupt occurs. The external device interface 121 of the external device 120 performs parallel-to-serial conversion of the received interrupt signal and serially transmits it to the mobile phone 100 through the power interface 113. When the external device interface 107 of the mobile phone 100 extracts the interrupt signal from the keyboard 124 by performing serial-to-parallel conversion of the received data, the external device interface 107 asserts the interrupt signal 112.

Upon receiving the interrupt signal, the processor 101 performs bus access (read or write) according to the above-described procedure. For example, the bus interface 102 enables the chip select signal 111 connected to the external device interface 107, such that the processor 101 reads the input data on the keyboard 124 from the external device 120 through the bus 110.

Subsequently, when the keyboard 124 negates the interrupt signal 132 by releasing the interrupt, the external device interface 121 of the external device 120 performs parallel-to-serial conversion of the received interrupt signal and serially transmits it to the mobile phone 100 through the power interface 113.

When the external device interface 107 of the mobile phone 100 extracts the interrupt signal from the keyboard 124 by performing serial-to-parallel conversion of the received data, the external device interface 107 negates the interrupt signal 112. As a result, the keyboard interrupt is also released in the mobile phone 100.

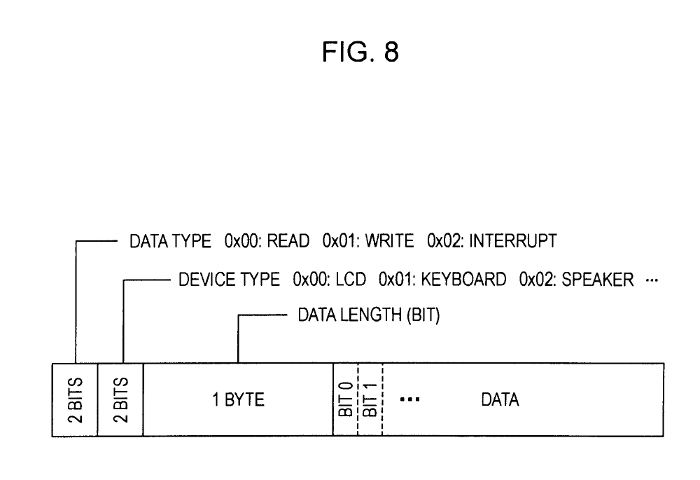

FIG. 8 illustrates a format example of the transmission frame between the mobile phone 100 and the external device 120.

The transmission frame shown in FIG. 8 includes fields of data type, device type, and data length in the header part.

The data type field has a 2-bit length and is used to distinguish to which of read, write, occurrence of interrupt, and release of interrupt the transmission frame corresponds. For example, it indicates read in the case of 0×00, write in the case of 0×01, and interrupt in the case of 0×02.

The device type field has a 2-bit length and is used to distinguish that the transmission frame is a read or write request to which device or to distinguish that the transmission frame is a request of occurrence or release of interrupt from which device. For example, it indicates an LCD in the case of 0×00, a keyboard in the case of 0×01, and a speaker in the case of 0×02.

The data length field has a 1-byte length, and the length of the data (payload) portion of the transmission frame is described in the bit number, for example.

Moreover, the bit 0 to the final bit are connected in the data portion of the transmission frame.

In addition, the transmission frame format shown in FIG. 8 is an example, and the present invention is not limited thereto. Any transmission frame format, which is appropriately defined according to the system to which the present invention is applied, may be used. In addition, functions of error detection and error correction using checksum and the like may be included in the transmission frame.

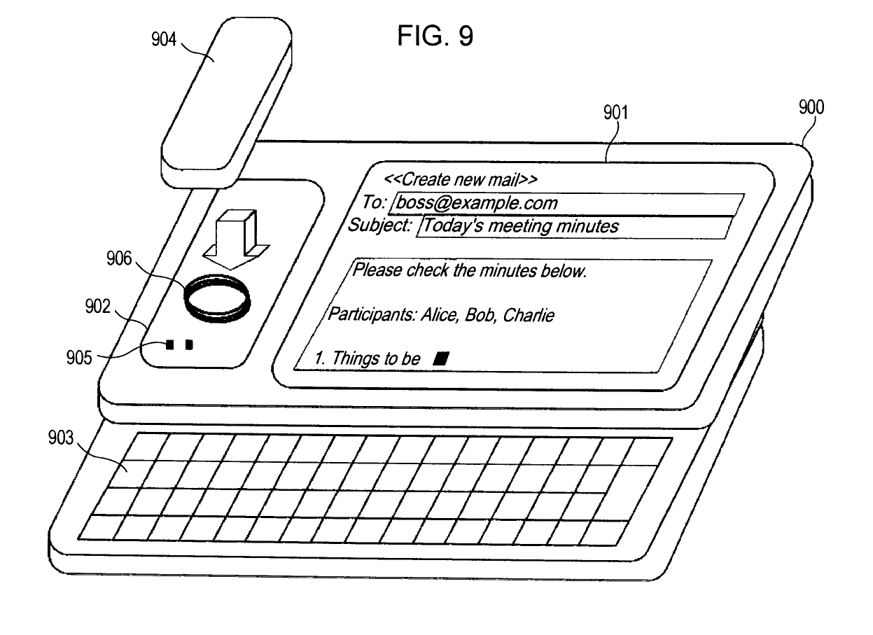

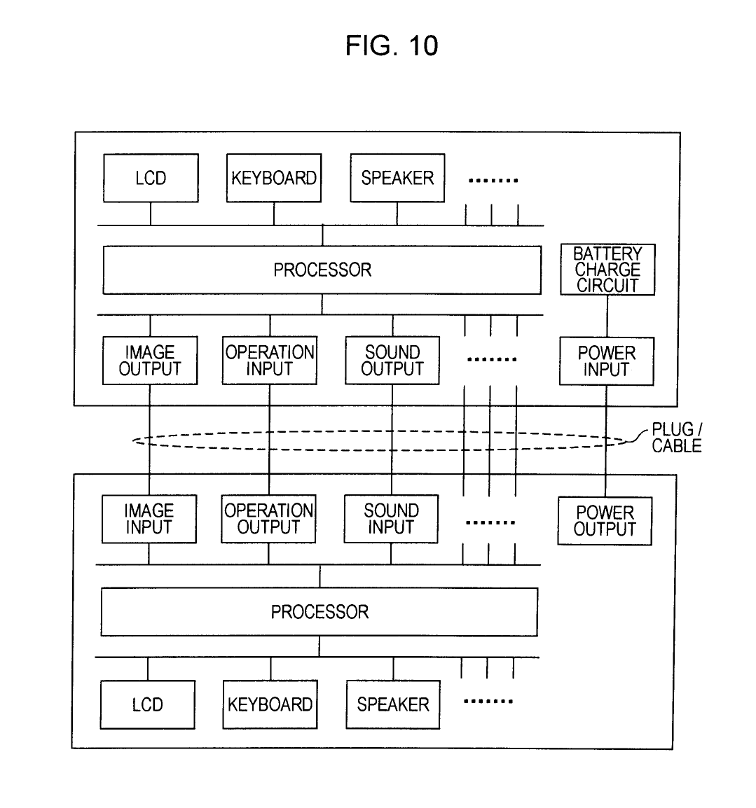

FIG. 9 is an illustration of an application image of the mobile terminal system shown in FIG. 1.

An external device 901 includes an LCD 901 with a relatively large screen and a keyboard 903 with all the keys in the QWERTY arrangement. By placing a mobile phone 904 on a connection section 902, a screen on the mobile phone 904 can be displayed on the LCD 901 and the mobile phone 904 can be operated by user input on the keyboard 903.

A contact point 905 connected with the mobile phone 904 is provided in the connection section 902, such that the mobile phone 904 can be charged and data transmission can be performed through the contact point 905.

However, when electric field transmission using the coil is performed as shown in FIGS. 4A and 4B, the contact point 905 between the external device 900 and the mobile phone 904 does not exist and the communication is performed through a coil 906 provided in the external device 900.

The present application contains subject matter related to that disclosed in Japanese Priority Patent Application JP 2008-266856 filed in the Japan Patent Office on Oct. 15, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A mobile terminal system including a mobile terminal and an external device, comprising:
a first external device interface which is provided in the mobile terminal in order to output screen information to the external device and to receive operation information from the external device;
a display section which is provided in the external device in order to display and output the screen information;
a user input section which is provided in the external device and is used when a user inputs the operation information on the mobile terminal; and
a second external device interface which is provided in the external device in order to receive the screen information from the mobile terminal and to output to the mobile terminal the operation information input through the user input section,
wherein transmission of the screen information and the operation information between the first and second external device interfaces is performed through a power signal used for the supply of power to the mobile terminal or for charging a battery in the mobile terminal.

2. A mobile terminal system including a mobile terminal and an external device, comprising:
a first external device interface which is provided in the mobile terminal in order to output screen information to the external device and to receive operation information from the external device;
a display section which is provided in the external device in order to display and output the screen information;
a user input section which is provided in the external device and is used when a user inputs the operation information on the mobile terminal; and
a second external device interface which is provided in the external device in order to receive the screen information from the mobile terminal and to output to the mobile terminal the operation information input through the user input section,
wherein each of the first and second external device interfaces includes a coil, and transmission of the screen information and the operation information is performed using the electric field between the coils.

3. The mobile terminal system according to claim 2,
wherein the coil provided in the first external device interface is a coil for power reception,
the coil provided in the second external device interface is a coil for power transmission, and
a battery in the mobile terminal is charged by using electromagnetic induction between the coils.

4. The mobile terminal system according to claim 1 or 2,
wherein the mobile terminal is a mobile phone, and
the screen information is video data or still image data received through a mobile phone network.

5. The mobile terminal system according to claim 1 or 3,
wherein the first and second external device interfaces perform parallel-to-serial conversion of transmission data and superimpose the converted data on the power signal and also reproduce received data superimposed on the power signal by performing serial-to-parallel conversion of the received data.

6. A mobile terminal that operates in the mobile terminal system according to claim 1, comprising:
a display section which outputs screen information;
a user input section which is used when a user inputs operation information on the mobile terminal;
a first external device interface for transmitting the screen information to the external device and receiving the operation information from the external device through a power signal used for the supply of power to the mobile terminal or for charging a battery in the mobile terminal; and
a processor which outputs the screen information to the display section or the first external device interface and performs an operation of the mobile terminal according to the operation information input by the user input section or the operation information read from the first external device interface.

7. A mobile terminal that operates in the mobile terminal system according to claim 1, comprising:
a display section which outputs screen information;
a user input section which is used when a user inputs operation information on the mobile terminal;
a first external device interface which includes a coil and transmits the screen information to the external device and receives the operation information from the external device using the electric field of the coil; and
a processor which outputs the screen information to the display section or the first external device interface and performs an operation of the mobile terminal according to the operation information input by the user input section or the operation information read from the first external device interface.

8. The mobile terminal according to claim 7,
wherein the coil provided in the first external device interface is a coil for power reception, and
a battery in the mobile terminal is charged by using electromagnetic induction between the coil provided in the first external device interface and a coil for power transmission provided in the second external device interface.

9. The mobile terminal according to claim 6 or 8,
wherein the first external device interface performs parallel-to-serial conversion of transmission data and superimposes the converted data on the power signal and also reproduces received data superimposed on the power signal by performing serial-to-parallel conversion of the received data.

10. An external device that operates in the mobile terminal system according to claim 1, comprising:
a user input section which is used when a user inputs operation information on the mobile terminal;
a second external device interface for receiving the screen information from the mobile terminal and transmitting the operation information to the mobile terminal through a power signal used for the supply of power to the mobile terminal or for charging a battery in the mobile terminal; and
a display section which outputs the screen information received from the mobile terminal.

11. An external device that operates in the mobile terminal system according to claim 1, comprising:
a user input section which is used when a user inputs operation information on the mobile terminal;
a second external device interface which includes a coil and receives the screen information from the mobile terminal and transmits the operation information to the mobile terminal using the electric field of the coil; and
a display section which outputs the screen information received from the mobile terminal.

12. The external device according to claim 11,
wherein the coil provided in the second external device interface is a coil for power transmission, and
a battery in the mobile terminal is charged by using electromagnetic induction between the coil provided in the second external device interface and a coil for power reception provided in the first external device interface.

13. The external device according to claim 10 or 12,
wherein the second external device interface performs parallel-to-serial conversion of transmission data and superimposes the converted data on the power signal and also reproduces received data superimposed on the power signal by performing serial-to-parallel conversion of the received data.

14. An input/output method of a mobile terminal in the mobile terminal system according to claim 1, comprising the steps of:
outputting the screen information from the first external device interface provided in the mobile terminal;
performing display output of the screen information, which has been input to the second external device interface provided in the external device, in the display section of the external device;
outputting the operation information, which has been input through the user input section of the external device, from the second external device interface; and
operating the mobile terminal according to the operation information input to the first external device interface,
wherein transmission of the screen information and the operation information between the first and second external device interfaces is performed through a power signal used for the supply of power to the mobile terminal or for charging a battery in the mobile terminal.

15. An input/output method of a mobile terminal in the mobile terminal system according to claim 1, comprising the steps of:
outputting the screen information from the first external device interface provided in the mobile terminal;
performing display output of the screen information, which has been input to the second external device interface provided in the external device, in the display section of the external device;
outputting the operation information, which has been input through the user input section of the external device, from the second external device interface; and
operating the mobile terminal according to the operation information input to the first external device interface,
wherein each of the first and second external device interfaces includes a coil, and transmission of the screen information and the operation information is performed using the electric field between the coils.
